(19) United States
(12) Patent Application Publication
(10) Pub. No.: US 2012/0204197 A1
(43) Pub. Date: Aug. 9, 2012

(54) OPTICAL DISC DEVICE

(76) Inventors: Koji MATSUMOTO, Tokyo (JP); Seiji Hamaie, Kawasaki (JP); Hideyuki Nagamine, Urayasu (JP)

(21) Appl. No.: 13/367,387

(22) Filed: Feb. 7, 2012

(30) Foreign Application Priority Data
Feb. 7, 2011 (JP) 2011-023923

(51) Int. Cl. G11B 17/03

(52) U.S. Cl. 720/613; G9B/17.009

(57) ABSTRACT

An optical disc device includes rails holding a tray so as to be put in and out with respect to a case and rail guides attached to a bottom chassis of the case to movably hold the rails, in which the rail guides have cross sections orthogonal to the running direction of the rails in a generally U shape and at least either one of the rail guides is formed with a projection in a part of the bottom surface abutting upon the rail. The projection is formed in an end range on the front face side of the case in the rail guide, and the rail rides on the projection of the rail guide when the tray is drawn out from the case.

### CLAIM OF PRIORITY

The present application claims priority from Japanese patent application serial No. JP 2011-023923 filed on Feb. 7, 2011 the content of which is hereby incorporated by reference into this application.

### BACKGROUND OF THE INVENTION

1. Field of the Invention

The present invention relates to an optical disc device recording and reproducing information to and from an optical disc, and relates specifically to a structure of a case storing a tray mounting the optical disc.

2. Description of the Related Art

In general, in an optical disc device mounted on an electronic system, a tray held by a device body (case) so as to be able to move thereinto and away therefrom is provided, and it is configured that the optical disc is mounted onto the device body by mounting the optical disc on the tray in a state the tray is drawn out from the case and storing the tray in the case again. Among the optical disc devices, in a slim type one built in a personal computer and the like, a spindle motor rotating the optical disc and an optical pickup movable in the radial direction of the optical disc, irradiating a laser beam to the recording surface of the disc and recording or reproducing the information are attached to the tray. Also, in the slim type optical disc device, because the height (thickness) of the case is limited, the rigidity of mechanical parts is low and the gap between the tray and the case is narrow. Accordingly, when an excessive external force is applied in mounting the optical disc and in putting in and out operation of the tray, a variety of troubles such as dropping off of the tray from the case and the like may possibly occur.

Aiming to prevent damage of the recording surface of the disc caused because the optical disc contacts the edge and the like of the tray in attaching and detaching the optical disc, the tray disclosed in Japanese Published Unexamined Patent Application No. 2009-059436 for example is configured that an edge corner part formed by a generally half-moon-shape flat recess facing the bottom surface of an optical disc and a side face part formed in a place corresponding to the chord of the generally half-moon-shape recess is chamfered into a circular-arc shape.

### SUMMARY OF THE INVENTION

A problem of the slim type optical disc device is that the bottom surface side of the tray and the inner surface of the case are liable to contact with each other when the tray is put in and out. That is, in the slim type optical disc device with the typical thickness of 12.7 mm, 9.5 mm and the like, because the gaps between parts are narrow and the parts are liable to deflect, when an excessive load is applied and the tray is slid, a bottom cover attached to the bottom surface of the tray may possibly rub against a bottom chassis which is the bottom surface of the case. As a result, the coating material on the surface of the bottom cover may possibly peel off and be damaged. Thus, in addition to spoiling the outward appearance of the tray, there is a risk that the metal surface of the base material is exposed due to peeling off of the coating material, static electricity comes from the outside, and the electronic parts mounted on the tray is electrostatically destructed (ESD).

According to prior arts to begin with the Japanese Published Unexamined Patent Application No. 2009-059436, the problem that the bottom surface side of the tray and the inner surface of the case contact with each other to damage the bottom cover is not considered.

The object of the present invention is to provide an optical disc device in which the surface of the bottom cover is not damaged by rubbing of the bottom cover against the bottom chassis when a tray is put in and out to and from a case.

The present invention is an optical disc device storing a tray mounted with an optical disc in a case and recording and reproducing information to and from the optical disc including rails holding the tray so as to be put in and out with respect to the case and rail guides attached to a bottom chassis of the case to movably hold the rails, in which the rail guides have cross sections orthogonal to the running direction of the rails in a generally U shape, and at least either one of the rail guides is formed with a projection in a part of the bottom surface abutting upon the rail.

Here, the projection is formed in an end range on the front face side of the case in the rail guide, and the rail rides on the projection of the rail guide when the tray is drawn out from the case.

According to the present invention, a reliable optical disc device without deterioration of the outward appearance and electrostatic destruction due to damaging against the bottom cover of the tray in putting in and out operation of the tray can be provided.

### BRIEF DESCRIPTION OF THE DRAWINGS

These and other features, objects and advantages of the present invention will become more apparent from the following description when taken in conjunction with the accompanying drawings wherein:

FIG. 1A is an external perspective view (on the front surface side) showing an embodiment of an optical disc device in relation with the present invention.

FIG. 1B is an external perspective view (on the back surface side) showing an embodiment of the optical disc device in relation with the present invention.

FIG. 2A is a perspective view (opened state) showing the internal constitution of the optical disc device of FIG. 1A and FIG. 1B.

FIG. 2B is a perspective view (closed state) showing the internal constitution of the optical disc device of FIG. 1A and FIG. 1B.

FIG. 3A is a perspective view showing an example of the shape of the projection formed in the rail guide 9.

FIG. 3B is a perspective view showing an example of the shape of the projection formed in the rail guide 9.

FIG. 4A is a schematic drawing showing a tray floating action (opened state) in the present embodiment.

FIG. 4B is a schematic drawing showing a tray floating action (closed state) in the present embodiment.

FIG. 5A is a schematic drawing showing a tray action (opened state) in a prior art for reference purpose.

FIG. 5B is a schematic drawing showing a tray action (closed state) in a prior art for reference purpose.

FIG. 6 is a drawing showing a hysteresis phenomenon of a floating action of the tray in the present embodiment.

### DETAILED DESCRIPTION OF THE EMBODIMENTS

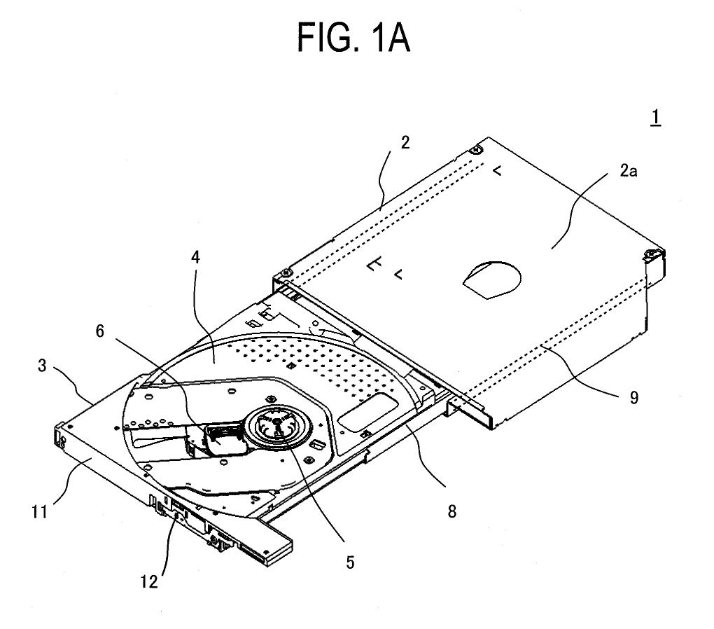

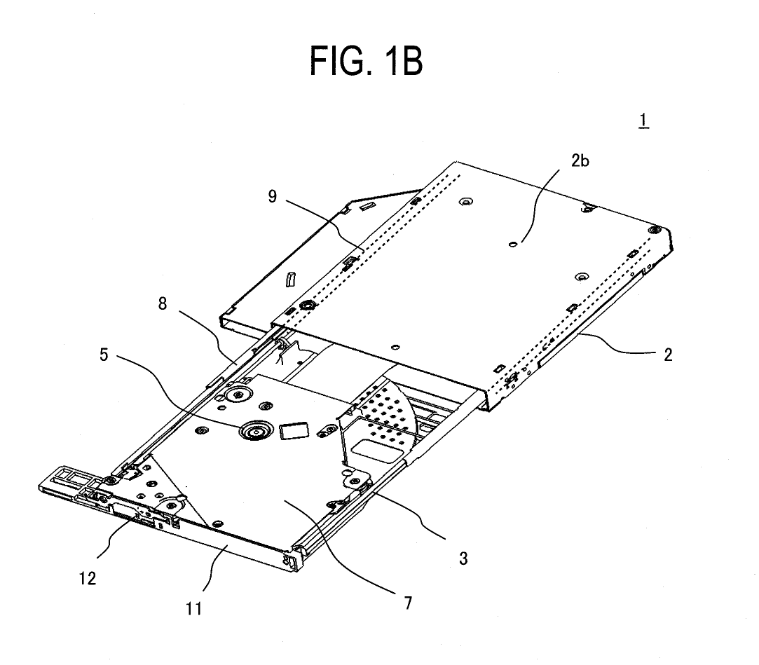

Below, preferred embodiments of the present invention will be described referring to the drawings. FIG. 1A and FIG. 1B are external views showing an embodiment of an optical disc device in relation with the present invention, FIG. 1A is a perspective view viewed from the front surface side (optical disc mounting side), and FIG. 1B is a perspective view viewed from the back surface side. In the drawings, 1 is an optical disc device, 2 is a case (chassis), 2a is a top case section (top case), 2b is a bottom case section (bottom chassis), 3 is a tray, 4 is a mounting surface, 5 is a spindle motor, 6 is an optical pickup, 7 is a bottom cover, 8 are rails, 9 are rail guides, 11 is a bezel, and 12 is an eject button.

The optical disc device 1 includes the case 2 and the tray 3 held by the case 2 so as to be put in and out to and from the case 2. The case 2 is in a bag shape combining the top case 2a and the bottom chassis 2b made of a metal and is configured to store the tray 3 through a front face side opening of the case 2. An optical disc is mounted on the mounting surface 4 on the front surface side of the tray 3. Also, the spindle motor 5 rotating the optical disc, the optical pickup 6 irradiating a laser beam onto the optical disc to record and reproduce information, and an electronic circuit board driving them are attached to the tray 3 and are supported from the back surface side of the tray 3 through the bottom cover 7. The optical pickup 6 moves in the radial direction of the optical disc by a feed motor not illustrated.

The tray 3 is moved for being stored and drawn out in and from the case 2 through the rails 8 attached to the side surfaces of the tray 3. Also, the rail guides 9 movably holding the rails 8 are arranged on the side surfaces of the bottom chassis 2b of the case 2. In order to smoothly move the tray 3 for being put in and out, a predetermined gap (clearance) is arranged between the rails 8 and the rail guides 9 and the rails 8 are attached so as to be movable with respect to the tray 3.

When the tray 3 is to be stored, the bezel 11 arranged on the front face of the tray 3 is pushed in to the case 2 side, an engaging part arranged in the case 2 and an engaging part arranged in the tray 3 are engaged with each other, and thereby the tray 3 is locked inside the case 2. On the other hand, when the tray 3 is to be drawn out, by pushing the eject button 12 arranged on the bezel 11, locking of the engaging part arranged in the case 2 and the engaging part arranged in the tray 3 is released, and the tray 3 is drawn out from the case 2 to the front face side.

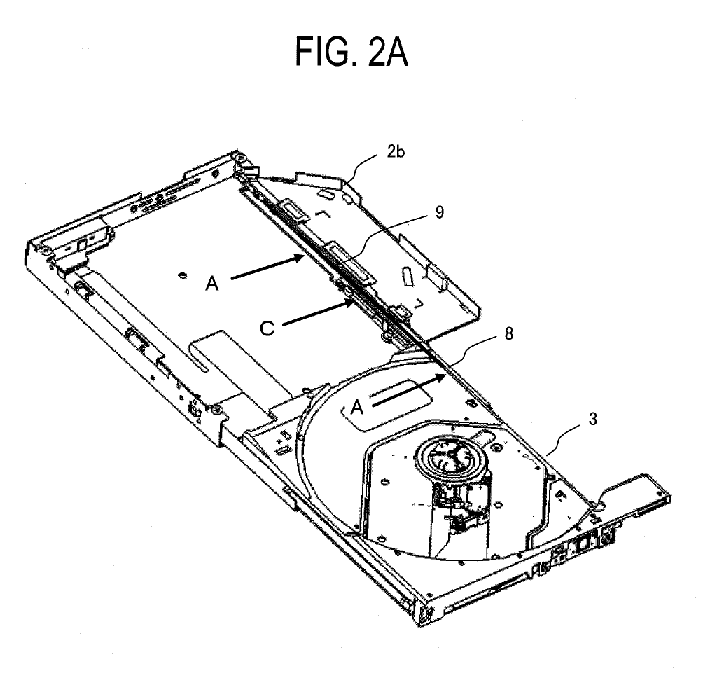

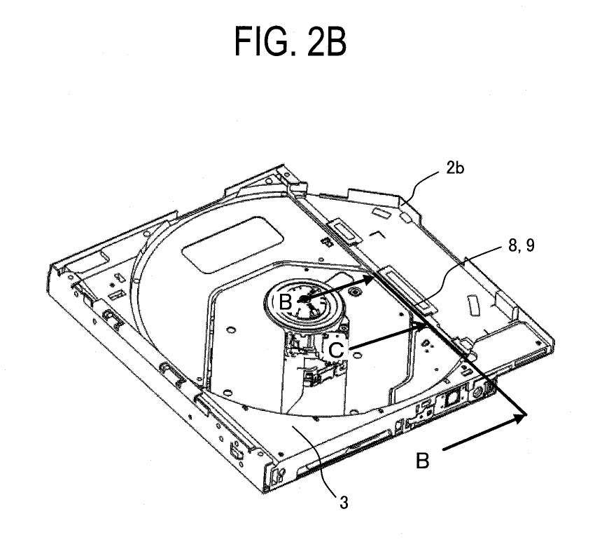

FIG. 2A and FIG. 2B show the internal constitution of the optical disc device of FIG. 1A and FIG. 1B with the top case 2a being removed, FIG. 2A is a perspective view showing a state the tray 3 is drawn out from the case 2 (opened state), and FIG. 2B is a perspective view showing a state the tray 3 is stored inside the case 2 (closed state). The rail guides 9 are fixed to the side surfaces of the bottom chassis 2b, and the rails are attached so as to be movable in the front and rear direction on the side surfaces of the tray 3 in the rear region of the tray 3.

In the opened state of FIG. 2A, the rear ends of the rails 8 attached to the tray 3 are inserted to the front ends of the rail guides 9 attached to the bottom chassis 2b, whereas in the closed state of FIG. 2B, entire rails 8 of the tray 3 are inserted to the rail guides 9 of the bottom chassis 2b. The present embodiment is characterized that the projection is arranged in the front end section (indicated by the mark C) of the rail guide 9 on the contacting surface against the rail 8. Thus, in the opened state of FIG. 2A, the tray 3 is made to float (depart) from the bottom chassis 2b by riding of the rail 8 on the projection of the rail guide 9. Also, in the closed state of FIG. 2B, the tray 3 is made to return to a normal height position by making the rails 8 retract toward the rear direction from the projection of the rail guide 9.

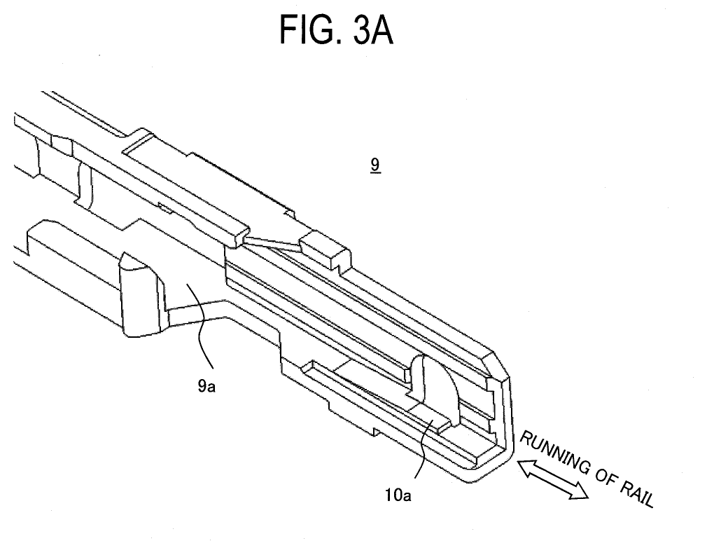

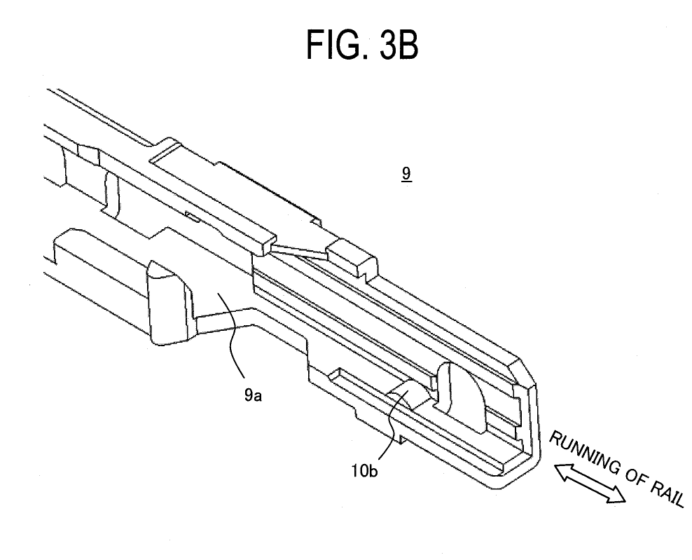

FIG. 3A and FIG. 3B are perspective views showing an example of the shape of the projection formed in the rail guide 9. In the rail guides 9, the cross section orthogonal to the running direction of the rails 8 is generally in U shape, and the rails run along the inner surfaces thereof. In the present embodiment, a projection 10a (FIG. 3A) or a projection 10b (FIG. 3B) is formed in a part of the bottom surface 9a abutting upon the rail 8 in the front end range of the rail guide 9. Accordingly, the rail 8 during running comes to ride on the projection 10a or the projection 10b. The projection 10a shown in FIG. 3A is formed in a trapezoidal shape having a gentle slope in the direction the rail 8 rides, the projection 10b shown in FIG. 3B is formed in an arc shape, and the rail 8 is allowed to ride on the projection 10a and 10b smoothly in both cases. The height of the projections 10a and 10b can be determined from the desired floating amount of the tray 3, and is made 0.3-0.5 mm for example. These projections 10a and 10b can be easily formed by integral forming work of the rail guide 9. The shape of the projection is not limited to these examples, and the projection may be formed separately from the rail guide 9. Two pieces of the rail guides 9 are present on the right and left side surfaces of the tray 3. The projection is arranged in the rail guide 9 on the right side in the present embodiment, however the projections may also be arranged in both rail guides 9.

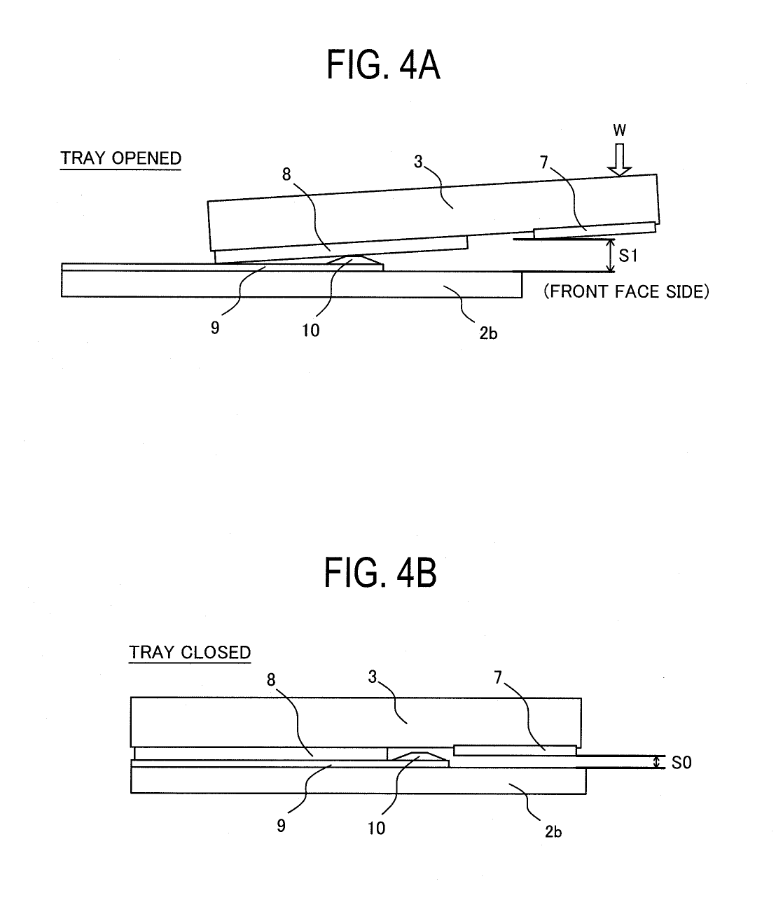

FIG. 4A and FIG. 4B are schematic drawings showing a tray floating action in the present embodiment. FIG. 4A is in the opened state and shows the cross section taken along the line A-A of FIG. 2A, and FIG. 4B is in the closed state and shows the cross section taken along the line B-B of FIG. 2B. In each drawing, the bottom cover 7 and the rails 8 are attached to the bottom surface of the tray 3, and the rails 8 are made movable in the rear range of the tray 3. Also, the rail guides 9 are attached to the upper surface of the bottom chassis 2b, and the projection 10 facing the rail 8 is formed in the front end range of the rail guide 9.

In the opened state of FIG. 4A, the tray 3 floats by riding of the rail 8 on the projection 10 of the rail guide 9, and the gap between the bottom cover 7 and the bottom chassis 2b increases to S1. In the closed state of FIG. 4B, the front end (right end in the drawing) of the rail 8 retracts to the rear side (left side in the drawing) of the projection 10 of the rail guide 9, the rail 8 contacts the bottom surface 9a of the rail guide 9, the tray 3 returns to the normal height position, and the gap between the bottom cover 7 and the bottom chassis 2b becomes a normal value S0.

In the putting in and out operation of the tray 3, when storing is started (when the state changes from the opened state of FIG. 4A to the closed state), the operation of the user to push in the front surface of the tray is added, and therefore a load W of a downward component is applied to the distal end of the tray 3. Because of the load W, the tray 3 deforms and comes to slightly sink to the bottom chassis 2b side, however because the gap between the bottom cover 7 and the bottom chassis 2b is made a large value of S1, the both do not contact and do not rub with each other. Accordingly, peeling off of the coating of the bottom cover 7 and generation of damage can be prevented.

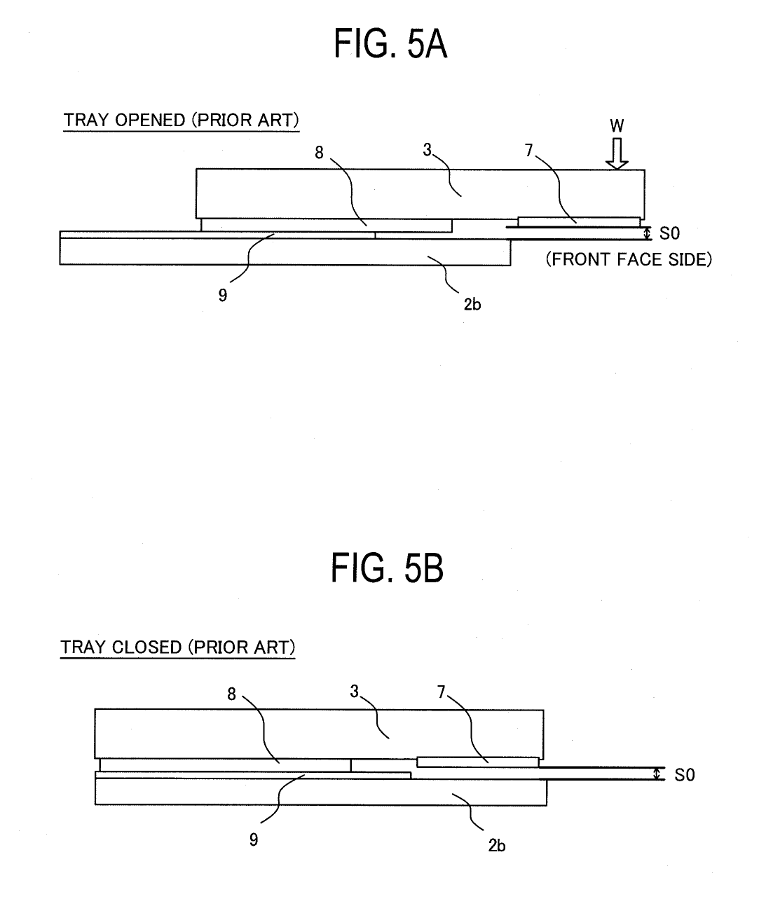

FIG. 5A and FIG. 5B are schematic drawings showing a tray action in a prior art for reference purpose. FIG. 5A is of an opened state and FIG. 5B is of a closed state. In the structure according to prior arts, the bottom surface (rail receiving surface) of the rail guide 9 is of a linear shape and has not a projection. Therefore, even in the opened state of FIG. 5A or in the closed state of FIG. 5B, the rail 8 contacts the bottom surface 9a of the rail guide 9, therefore the tray 3 runs maintaining a constant height, and the gap between the bottom cover 7 and the bottom chassis 2b remains unchanged at a constant value S0.

In the putting in and out operation of the tray 3, when storing is started (FIG. 5A), a load W is applied to the distal end of the tray 3, and, because of the load W, the tray 3 deforms and comes to slightly sink to the bottom chassis 2b side. With the ordinary gap amount S0 between the bottom cover 7 and the bottom chassis 2b, the sinking amount of the tray 3 cannot be fully absorbed, and there may be a case the both contact and rub against each other. As a result, the coating on the surface of the bottom cover 7 is peeled off, and the damage is caused.

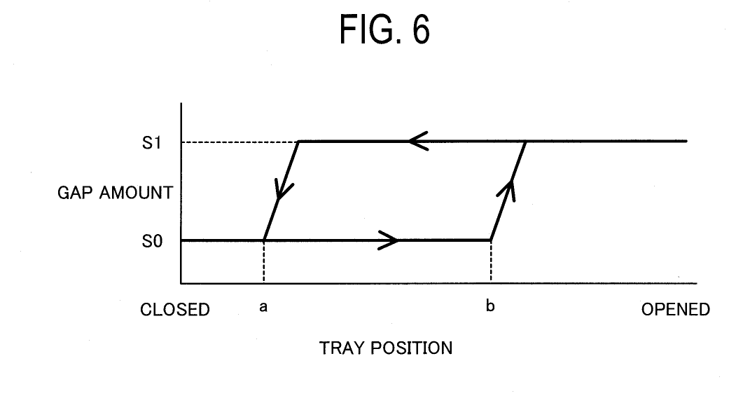

FIG. 6 is a drawing showing a hysteresis phenomenon of a floating action of the tray in the present embodiment. In FIG. 6, the relation between the opening and closing position of the tray and the gap amount between the bottom cover 7 and the bottom chassis 2b is shown. The gap amount is S0 in the closed state of the tray 3 and is S1 in the opened, however the position of switching is the position a in storing the tray and is the position b in drawing out, and the floating action exhibits a hysteresis phenomenon. The reason is that the rails 8 holding the tray 3 are attached so as to be movable in a predetermined section with respect to the tray 3. Because of the hysteresis, the section where the gap amount becomes S1 is long in the tray storing step, but becomes short in the drawing out step. However, when the tray is drawing out, a user does not touch the tray 3, therefore there is no possibility that the load W is applied to the tray 3 and the bottom cover 7 contacts the bottom chassis 2b, and the problem is not caused.

As described above, according to the present embodiment, the tray 3 is floated by providing the projection 10 on the rail guide 9, and the damage on the bottom cover 7 is prevented even when a load is applied to the tray 3. Thus, a reliable optical disc device without the risk of deterioration of the outward appearance and electrostatic destruction can be provided.

What is claimed is:

1. An optical disc device storing a tray mounted with an optical disc in a case and recording and reproducing information to and from the optical disc comprising:
rails holding the tray so as to be put in and out with respect to the case; and
rail guides attached to a bottom chassis of the case to movably hold the rails, wherein
the rail guides have cross sections orthogonal to the running direction of the rails in a generally U shape, and
at least either one of the rail guides is formed with a projection in a part of the bottom surface abutting upon the rail.

2. The optical disc device according to claim 1, wherein
the projection is formed in an end range on the front face side of the case in the rail guide; and
the rail rides on the projection of the rail guide when the tray is drawn out from the case.

3. The optical disc device according to claim 2, wherein
the projection is of a gentle slope shape in the direction the rail rides thereon.

4. The optical disc device according to claim 2, wherein
a section where the rail rides on the projection of the rail guide is longer in a step the tray is stored in the case than that in a step the tray is drawn out from the case.

5. An optical disc device storing a tray mounted with an optical disc in a case and recording and reproducing information to and from the optical disc, comprising:
rails holding the tray so as to be put in and out with respect to the case; and
rail guides attached to a bottom chassis of the case to movably hold the rails, wherein
a projection for preventing a bottom cover attached to a bottom surface of the tray from contacting a bottom chassis of the case and being damaged when the tray is deformed is formed on a surface of the rail guide abutting upon the rail.
